(19) United States
(12) Patent Application Publication
(10) Pub. No.: US 2011/0138634 A1
(43) Pub. Date: Jun. 16, 2011

(54) PRUNING MACHINE WITH AN EXTENDING ROD

(75) Inventors: Toshinari Yamaoka, Nanjing (CN); Wei Jiang, Nanjing (CN)

(73) Assignee: Chervon Limited, Wanchai (HK)

(21) Appl. No.: 12/967,524

(22) Filed: Dec. 14, 2010

(30) Foreign Application Priority Data
Dec. 15, 2009 (CN) 200920284588.2

(51) Int. Cl. A01G 3/08

(52) U.S. Cl. 30/277.4

(57) ABSTRACT

The present application provides a pruning machine with an extendible rod. The pruning machine also includes a main body and a battery pack. The main body has a housing, a blade group, a motor, a transmission device and a switch on the outside of the housing. The battery pack has a plug to connect with a socket on the main body. One end of the extendible rod has the same plug as the battery pack to connect with the socket of the main body plug and the other end has the same socket of the main body to receive the plug of the battery pack. By using the same plug and socket structure throughout, the present application provides good adaptability and is suitable for a wide range of pruning operations.

### CROSS-REFERENCE TO RELATED APPLICATIONS

This application claims priority under 35 U.S.C. § 119 to CN 200920284588.2 filed Dec. 15, 2009, which may be hereby incorporated by reference.

### FEDERALLY SPONSORED RESEARCH OR DEVELOPMENT

Not Applicable.

### TECHNICAL FIELD

The present utility model relates to a gardening instrument and more particularly to a pruning machine for pruning flowers, grass and trees.

### BACKGROUND OF THE INVENTION

Current versions of pruning machines have high work efficiency and are highly portable. They are configured with a housing having a motor and a transmission mechanism. A control switch may be provided on the outside of the housing and blades may be provided at the front end of the housing. The blades may include a moving blade driven by the transmission device and a stationary blade. The pruning machine may also have a detachable battery pack connected with the rear end of the housing. The pruning machine may also have a telescopic extendible rod arranged between the battery pack and the main body to allow for a longer reach of operation. However, in previous pruning machines, the plug-in connection structure from the battery pack through the extendible rod to the housing is not uniform and an additional accessory is generally needed when the battery pack and the extendible rod are interchanged with each other resulting in a higher product cost and an inconvenient method of interchanging the elements of the pruning machine.

### SUMMARY OF THE INVENTION

To overcome the defects of the above described pruning machines, the present application provides a pruning machine with an extendible rod, which provides increased adaptability in the plug-in connection between the extending rod, the main body and the battery pack, and is suitable for a wide range of pruning operations.

Specifically, the present application discloses a pruning machine with an extendible rod having a main body, an extendible rod and a battery pack. The main body having a housing, a blade group arranged on the front end of the housing, a motor and a transmission mechanism arranged in the housing and a switch on the housing. The battery pack may have a plug corresponding with a socket provided at the rear end of the main body to allow for mating with the plug of the battery pack. The extendible rod may have a similar plug located at the front end of the extendible rod for mating with the socket of the main body and a socket being provided at the rear end of the extendible rod for mating with the plug of the battery pack. Further, the socket of the main body may have the same structure as that of the extendible rod and the plug of the extendible rod may have the same structure as that of the battery pack. The extendible rod may also have a switch.

In addition, the present application also discloses a control circuit board for alternatively setting the switch of the main body or the switch of the extendible rod in a operating state. Specifically, a pair of contacts are arranged at the connection portion between the plug of the extendible rod and the socket of the main body. The electrical signals of the pair of the contacts may be then transmitted to the control circuit board. A buckle for securing the extendible rod may also be further arranged at the connection portion between the main body and the extendible rod.

As a result of the above improvements, the end of the extendible rod connected to the main body is configured with the same plug structure as the battery pack. This allows the extendible rod to be directly connected to the main body without other additional auxiliary structures. Also, the rear end of the extendible rod is the same as the plug-in structure of the battery pack and the main body may be the same as the plug-in structure of the battery pack which allows the battery pack to be directly mounted without other additional auxiliary structures. Further, the present application discloses a control circuit board for controlling the switch of the main body to automatically determine the operating state of the machine to effectively avoids the misoperation of the pruning machine. Finally, the present application provides a telescopic function which may have a related buckle arranged at the connection portion of the extendible rod and the main body to allow for a wide range of pruning operations while still providing a stable, sturdy connection.

### BRIEF DESCRIPTION OF THE DRAWINGS

To understand the present invention, it will now be described in detail with reference to the accompanying drawings in which:

FIG. 1 is a perspective view of the pruning machine without an extendible rod according to the present application;

FIG. 2 is an exploded view of the pruning machine of FIG. 1;

FIG. 3 is a perspective view of the pruning machine with an extendible rod according to the present application;

FIG. 4 is an exploded view of the pruning machine of FIG. 3;

FIG. 5 is a sectional view of the plug-in structure of the present application; and,

FIG. 6 is a partial enlarged view of section A in FIG. 5.

### DETAILED DESCRIPTION

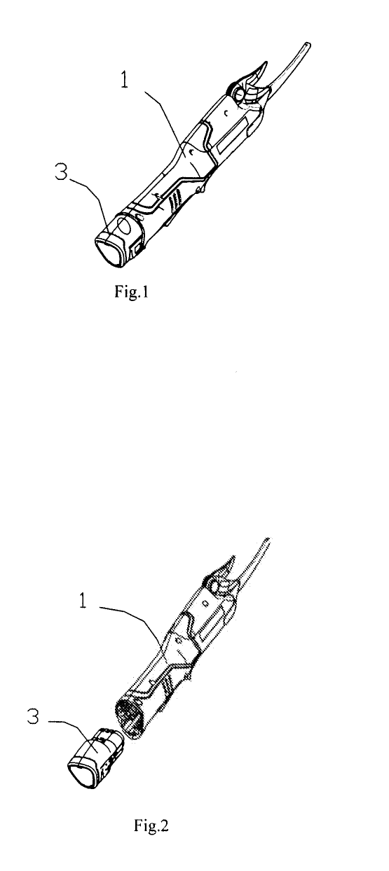

FIGS. 1 and 2 show the pruning machine without an extendible rod according to the present application and the exploded view of the same components respectively. The pruning machine includes a main body 1 and a battery pack 3, where a plug of the battery pack 3 can be mated with an socket of the main body 1.

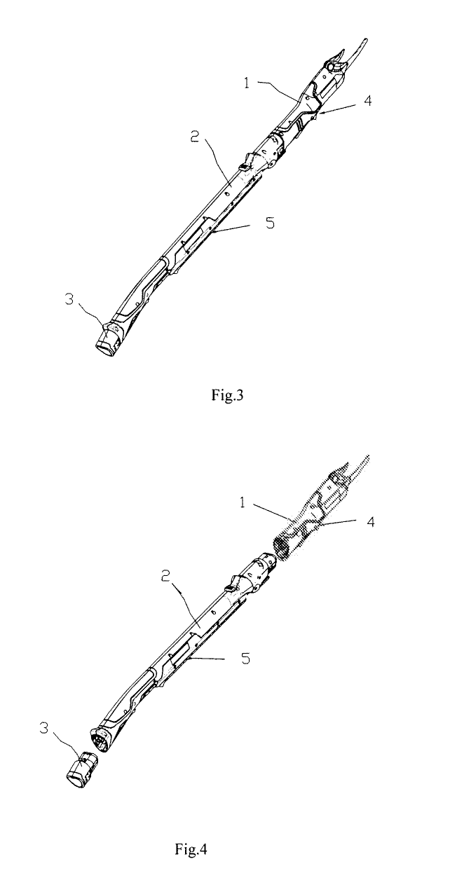

FIGS. 3 and 4 show the pruning machine with an extendible rod according to the present application and the exploded view of the same components respectively. The pruning machine includes the main body 1, an extendible rod 2 and the battery pack 3. One end of the extendible rod 2 may be connected to the main body 1 using the same structure as the plug of the battery pack 3 to facilitate connection with the socket of the main body and to directly connect the extendible rod with the main body. Meanwhile, the other end of the extendible rod 2 connected to the battery pack 3 has the same structure as the socket of the main body, to allow the battery pack 3 to directly connect the extendible rod 2 with the battery pack 3. Because the end of the extendible rod 2 connected to the main body is constructed with the same plug-in structure as the battery pack, the extendible rod can be directly connected to the main body without other additional auxiliary structures. Also, since the plug-in structure of the battery pack at the rear end of the extendible rod is the same as the plug-in structure of the battery pack on the main body the battery pack can be directly mounted without other auxiliary structures.

Further, as shown in FIG. 5, a buckle 7 may be added in the connection portion between the extendible rod 2 and the main body 1 for enhancing the reliability of the connection portion. The buckle 7 allows the extendible rod to be connected to the main body more securely and more firmly.

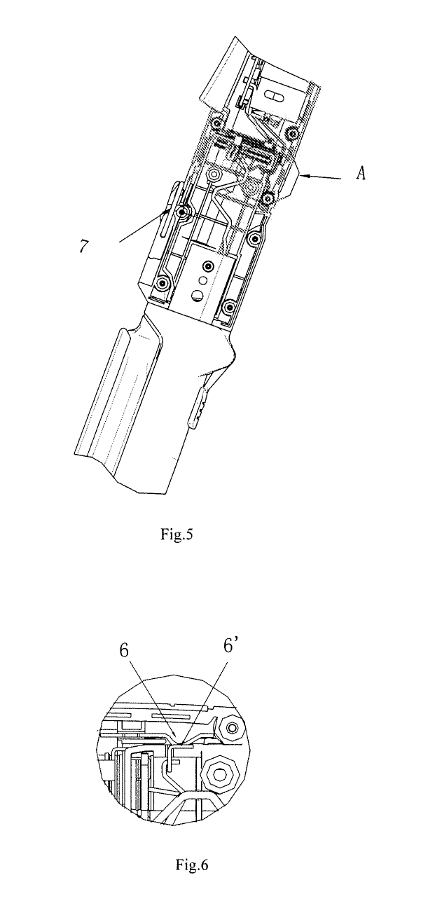

As shown in FIGS. 5 and 6, a pair of contacts 6, 6′ are arranged in the connection portion of the extendible rod 2 and the main body 1. The electrical signals of the pair of contacts are transmitted to a control circuit board by which the application can use a switch 4 of the main body 1 to control the operating state of the pruning machine. Specifically, when the main body 1 is connected to the extendible rod 2, the battery pack 3 is in use after being inserted into the extendible rod 2, thus the switch 4 of the main body is out of service and the pruning machine can be started only by a switch 5 of the extendible rod. To accomplish this result, when the extendible rod 2 is inserted into the main body 1, the contact of the extendible rod comes into touch the contact of the main body to turn on the control circuit board, so that the switch 4 of the main body is out of service while the switch 5 of the extendible rod is enabled. When the main body 1 is connected to the battery pack 3, the battery pack 3 is directly inserted onto the main body 1. Since there is no contact arranged on the battery pack 3, the control circuit board is off, so that the switch 4 of the main body can function normally and control the operation of the pruning machine.

What is claimed is:

1. A pruning machine with an extendible rod, comprising:
a main body;
an extendible rod;
a battery pack;
wherein the main body further comprises a housing, a blade group arranged on the front end of the housing, a motor, a transmission device, and a first switch on the housing;
the battery pack further comprises a first connection structure, the rear end of the main body having a second connection structure designed to be coupled with the first connection structure of the battery pack; and,
wherein one end of the extendible rod has the first connection structure to allow for coupling with the main body and the other end of the extendible rod has the second connection structure to allow for coupling with the battery pack.

2. The pruning machine according to claim 1, further comprising a second switch on the extendible rod.

3. The pruning machine according to claim 1, further comprising a control circuit board for controlling the operation of the first switch on the housing and the second switch on the extendible rod.

4. The pruning machine according to claim 3, wherein contacts are positioned in the coupling of the main body and the extendible rod such that the electrical signals of the contacts are transmitted to the control circuit board.

5. The pruning machine according to claim 1, further comprising a buckle for securing the extendible rod to the main body.

6. A pruning machine with an extendible rod, comprising:
a main body;
an extendible rod;
a battery pack;
wherein the main body further comprises a housing, a blade group arranged on the front end of the housing, a motor, a transmission device, and a first switch on the housing;
the battery pack further comprises a first connection structure, the rear end of the main body having a second connection structure designed to be coupled with the first connection structure of the battery pack;
wherein one end of the extendible rod has the first connection structure to allow for coupling with the main body and the other end of the extendible rod has the second connection structure to allow for coupling with the battery pack;
wherein the extendible rod has a second switch on the extendible rod;
a control circuit board for controlling the operation of the first switch on the housing and the second switch on the extendible rod and wherein contacts are positioned in the coupling of the main body and the extendible rod such that the electrical signals of the contacts are transmitted to the control circuit board; and,
a buckle for securing the extendible rod to the main body.
